(19) United States
(12) Patent Application Publication
(10) Pub. No.: US 2018/0260123 A1
(43) Pub. Date: Sep. 13, 2018

(54) SEPARATION OF DATA STORAGE MANAGEMENT ON STORAGE devices FROM LOCAL CONNECTIONS OF STORAGE DEVICES

(71) Applicant: Lenovo Enterprise Solutions (Singapore) PTE. LTD., New Tech Park (SG)

(72) Inventors: Mark E. Andresen, Cary, NC (US); Michael Neil Condict, Hurdle Mills, NC (US); David W. Cosby, Raleigh, NC (US); Jonathan Randall Hinkle, Morrisville, NC (US)

(21) Appl. No.: 15/451,718

(22) Filed: Mar. 7, 2017

(51) Int. Cl. G06F 3/06

(52) U.S. Cl. CPC G06F 3/0605; G06F 3/0631; G06F 3/0683; G06F 3/067; G06F 3/0655

(57) ABSTRACT

A storage system includes storage devices that each have a physical medium on which to store metadata regarding the storage device, and client data. The storage system includes a storage manager remotely connected to the storage devices to manage storage of the client data on the storage devices. The storage system includes an event manager separate from the storage manager and locally connected to the storage devices to directly manage the metadata stored on the storage devices, to receive local insertion, removal, and reinsertion events regarding the storage devices, and to send notifications regarding the removal and the reinsertion events to the storage manager. Separation of the storage manager from the event manager permits the storage manager to manage the storage of the client data on the storage devices regardless of a particular event manager to which each storage device is currently locally connected.

### BACKGROUND

Data is the lifeblood of many entities like businesses and governmental organizations, as well as individual users. At a granular level, data is stored on individual storage devices, such as magnetic disk drives and solid-state drives (SSDs). Such storage devices include physical storage media, such as rotatable magnetic platters or solid-state semiconductor memory, on which the devices store data. Storage devices include conventional “dumb” drives as well as more recent programmable or “smart” drives. The former lack any processing capability other than internal read/write controllers to manage low-level access on the data stored on the physical storage media of the drives. The latter, by comparison, generally include processors and limited amounts of memory to permit the drives to have operating systems installed thereon and run relatively small-scale applications.

### SUMMARY

An example storage system includes storage devices that each have a physical medium on which to store metadata regarding the storage device and client data. The storage system includes a storage manager remotely connected to the storage devices to manage storage of the client data on the storage devices. The storage system includes an event manager separate from the storage manager and locally connected to the storage devices to directly manage the metadata stored on the storage devices, to receive local insertion, removal, and reinsertion events regarding the storage devices, and to send notifications regarding the removal and the reinsertion events to the storage manager

An example computer-readable data storage medium that is not a transitory signal stores computer-executable code that an event manager separate from a storage manager managing client data storage executes. The event manager executes the code to detect connection of a storage device, and in response to detecting the connection of the storage device, determine whether the storage device has an administrative section including metadata regarding the storage device. The event manager executes the code to, in response to determining that the storage device has the administrative section, determining that a local reinsertion event of the storage device has occurred. The event manager executes the code to, in response to determining that the local reinsertion event has occurred, retrieve the metadata from the administrative section of the storage device. The event manager executes the code to retrieve information regarding the storage manager that previously managed the storage of the client data on the storage device. The event manager executes the code to send a notification regarding the local reinsertion event to the storage manager identified within the retrieved information, and store a copy of the metadata locally within a local storage of the event manager.

An example event manager apparatus includes a local storage interface, and storage devices. Each storage device is connected to the local storage interface and has a physical medium on which to store metadata regarding the storage device and client data. The event manager apparatus includes a network interface to connect to a network to which a storage manager managing storage of the client data on the storage devices is connected. The event manager apparatus includes an event manager to directly manage the metadata stored on the storage devices, to receive local insertion, removal, and reinsertion events regarding the storage devices, and to send notifications regarding the removal and the reinsertion events to the storage manager over the network.

### BRIEF DESCRIPTION OF THE DRAWINGS

The drawings referenced herein form a part of the specification. Features shown in the drawing are meant as illustrative of only some embodiments of the invention, and not of all embodiments of the invention, unless otherwise explicitly indicated, and implications to the contrary are otherwise not to be made.

FIG. 1 is a diagram of an example logical architectural topology of a system including storage devices, event managers, and a storage manager.

FIG. 2A is a diagram of an example physical architecture topology that can implement the logical topology of FIG. 1.

FIG. 2B is a block diagram of an example event manager device for usage within the physical topology of FIG. 2A.

FIG. 3 is a diagram of example data stored within a system including storage devices, an event manager, and a storage manager.

FIG. 4 is a flowchart of an example method that an event manager performs responsive to local connection of a storage device to the event manager.

FIG. 5 is a flowchart of an example method that an event manager performs responsive to local reconnection of a storage device to any event manager.

FIG. 6 is a flowchart of an example method that an event manager performs responsive to local disconnection of a storage device from the event manager.

### DETAILED DESCRIPTION

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the embodiment of the invention is defined only by the appended claims.

As noted in the background section, at a granular level data is stored on individual storage devices like magnetic disk drives and solid-state drives (SSDs). To provide for robust data storage and higher-level storage functionality, such as redundant array of independent disks (RAID) functionality, conventional storage drives that lack the ability to run operating systems themselves are commonly physically grouped and subsequently managed by a local controller. For example, a stand-alone network-attached storage (NAS) device may include a number of storage devices and a controller that exposes the storage devices over one or more logical storage drives to client computing devices on a network. As another example, a storage-area network (SAN) cluster can include multiple storage drives and a storage controller that hides the complexity of an underlying implementation of logical storage volumes from client computing devices.

In these cases, the controller governs both management of the storage drives to which it is directly connected as well as access to data stored on the storage drives. As storage drives such as solid-state drives have increased in performance, and as computing assets have become increasingly distributed—including over cloud-computing topologies—the shortcomings associated with such a centralized controller have become apparent. For instance, even the highest performance controller can become a bottleneck when connected to a large number of high performance storage devices and/or when servicing a large number of client computing devices. Furthermore, the storage devices themselves remain inextricably tethered to their host controller, and cannot be transitioned to different controllers that may be more physically proximate to the client computing devices primarily accessing the data stored on the storage devices.

One solution to this problem is a distributed SAN including a number of fabric-attachable storage drives. A SAN manager solely manages the storage drives and does not govern access to data stored on the drives, which is instead directly accessed by client computing devices running SAN agents. Such a technique is described in the patent application previously filed on Oct. 17, 2016, and assigned application Ser. No. 15/295,596. This solution can require storage drives that, even if not fully programmable, have at least a minimum capability to provision logical drive volumes on their physical storage media. As such, the solution may not be able to be implemented with more conventional “dumb” drives that lack even this minimum processing capability.

Disclosed herein, by comparison, are techniques that can provide for distributed management of storage devices in a similarly high-performance manner even when the storage devices lack processing capability beyond that which is found in conventional storage devices. The techniques described herein separate the management of data stored on the storage devices from where the devices are locally connected. A storage device may be temporarily physically disconnected at its current location, and upon physical reconnection at a new location (potentially closer to the client computing devices accessing the data stored on the storage device), remain under the management of the same storage manager.

Specifically, an event manager is provided that is separate from the storage manager. Whereas the storage manager is remotely connected to the storage devices, the event manager is locally connected to them. The event manager directly manages metadata stored on the storage devices, and manages local insertion, removal, and reinsertion events regarding the devices. As such, when a storage device is disconnected from one event manager and connected to another event manager, the former event manager sends any storage manager managing data stored on the device a notification regarding the removal event, and then the latter event manager sends the storage managers a notification regarding the reinsertion event. Even though the storage managers are remote to the storage device, they are kept apprised of the location of the device and can continue managing the storage device regardless of the device's physical location, and thus regardless of the event manager to which the storage device is currently locally connected.

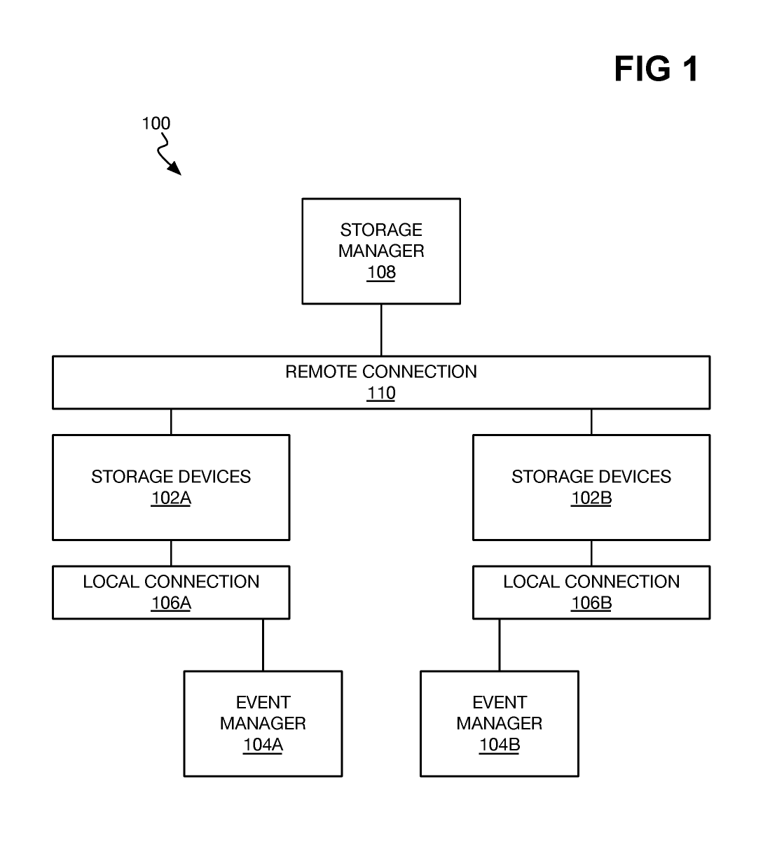

FIG. 1 shows an example logical architectural storage topology 100. The logical topology 100 includes one or more storage devices 102A and one or more storage devices 102B, which are collectively referred to as the storage devices 102. As used herein, the singular phrase “storage device 102A” refers to one of the storage devices 102A. Similarly, the singular phrase “storage device 102B” refers to one of the storage devices 102B, and the singular phrase “storage device 102” refers to one of the storage devices 102.

The logical topology 100 includes two event managers 104A and 104B, which are collectively referred to as the event managers 104. The singular phrase “event manager 104” refers to either of the event managers 104A and 104B. Two event managers 104 are depicted in FIG. 1 as an illustrative example. However, there can be more than two event managers 104, and as few as one event manager 104.

The storage devices 102A are locally connected to the event manager 104A via a local connection 106A, and the storage devices 102B are locally connected to the event manager 104B via a local connection 106B. The local connections 106A and 106B are collectively referred to as the local connections 106, and the singular phrase “local connection 106” refers to either of the local connections 106A and 106B. The storage devices 102A are not locally connected to the event manager 104B, and the storage devices 102B are not locally connected to the event manager 104A.

A storage manager 108 is remotely connected via a remote connection 110 to the storage devices 102 and can be remotely connected via the remote connection 110 to the event managers 104. The storage manager 108 is not locally connected to the storage devices 102. The storage manager 108 can in one implementation, however, be locally connected to the event managers 104 (via different local connections than the local connection 106 that locally connect the event managers 104 to the storage devices 102), instead of being remotely connected to the event managers 104. One storage manager 108 is depicted in FIG. 1 as an illustrative example. However, there can be more than one storage manager 108.

The local connections 106 differ from the remote connection 110 at least in that the local connections 106 permit the event managers 104 to automatically detect when a storage device 102 has been connected to or disconnected from a local connection 106, whereas the remote connection 110 may not. The local connections 106 may also be faster in data rate performance than the remote connection 110. The local connections 106 may provide for more physical proximity between the event managers 104 and the storage devices 102 than the remote connection 110 does between the storage manager 108 and the storage devices 102. The number of storage devices 102 that can connect to an event manager 104 via a local connection 106 may be more limited than the number of storage devices 102 that can connect to the storage manager 108 via the remote connection 110. The local connections 106 may be direct physical connections.

The first time a storage device 102 is connected to any local connection 106, the respective event manager 104 detects this connection, which is referred to as a local insertion event. When a storage device 102 is disconnected from a local connection 106, the respective event manager 104 detects this disconnection, which is referred to as a removal event. When a storage device 102 is again connected to any local connection 106, regardless of whether it is the same or different local connection 106 than that to which the device 102 was previously connected, the respective event manager 104 detects this connection, which is referred to as a local reinsertion event.

For example, a storage device 102 may first be connected to the local connection 106A. The event manager 104A detects this connection as a local insertion event. When the storage device 102 is disconnected from the local connection 106A, the event manager 104A detects this disconnection as a local removal event. If the storage device 102 is then connected to the local connection 106B, the event manager 104B detects this connection as a local reinsertion event, even though the storage device 102 was previously connected to the local connection 106A and not to the local connection 106B. If the storage device 102 is instead reconnected to the local connection 106A, the event manager 104A detects this connection as a local reinsertion event as well.

Once a storage device 102 has been connected for the first time to a local connection 106, the storage device 102 can be configured to store client data under the management of the storage manager 108. The client data is accessible by client computing devices, which may be separate from or include the storage manager 108. The storage manager 108 manages the storage of the client data. As such, if the storage manager 108 is not part of a client computing device that accesses client data, the storage manager 108 may not even be permitted to access the client data.

The storage manager 108 manages the storage of client data on a storage device 102 in that the storage manager 108 can control how logical storage volumes, for instance, are instantiated on a storage device 102, and whether the storage device 102 acts in concert with one or more other storage devices 102 to provide higher-level storage functionality, such as RAID. For example, a mirroring topology may be implemented between a storage device 102A and a storage device 102B. Any data stored by a client computing device on either storage device 102A or 102B is mirrored to the other storage device 102B or 102A in this example. The storage manager 108 can also manage the storage of client data on the storage device 102, on behalf of client computing devices, as described in patent application Ser. No. 15/295,596 referenced above.

The event managers 104 do not participate in the management of client data storage. Rather, the event managers 104 send notifications to the storage manager 108 regarding removal and reinsertion events of the storage devices 102 after the storage devices 102 have been configured to store client data under the management of the storage manager 108. Such notifications can inform the storage manager 108 where the storage devices 102 are located, and how to access the storage devices 102 when they are reconnected to a different local connection 106 than the local connection 106 to which they were previously connected.

For example, a storage device 102 connected to the local connection 106A may be accessible over the remote connection 110 in a different manner than the storage device 102 connected to the local connection 106B. Therefore, if a storage device 102 is disconnected from the local connection 106A and subsequently connected to the local connection 106B, the storage manager 108 is able to learn this information from the event managers 104. Specifically, the event manager 104A sends a notification regarding the removal event of the storage device 102 from the local connection 106A, and the event manager 104B sends a notification regarding the reinsertion event of the storage device 102 to the local connection 106B.

As noted above, there can be more than one storage manager 108. If there are multiple storage managers 108, different storage managers 108 may manage client data storage on different storage devices 102. Furthermore, more than one storage manager 108 may manage client data storage on the same storage device 102. This permits a storage device 102 to store client data as managed by different storage managers 108, regardless of whether the storage device 102 is connected to the local connection 106A or to the local connection 106B.

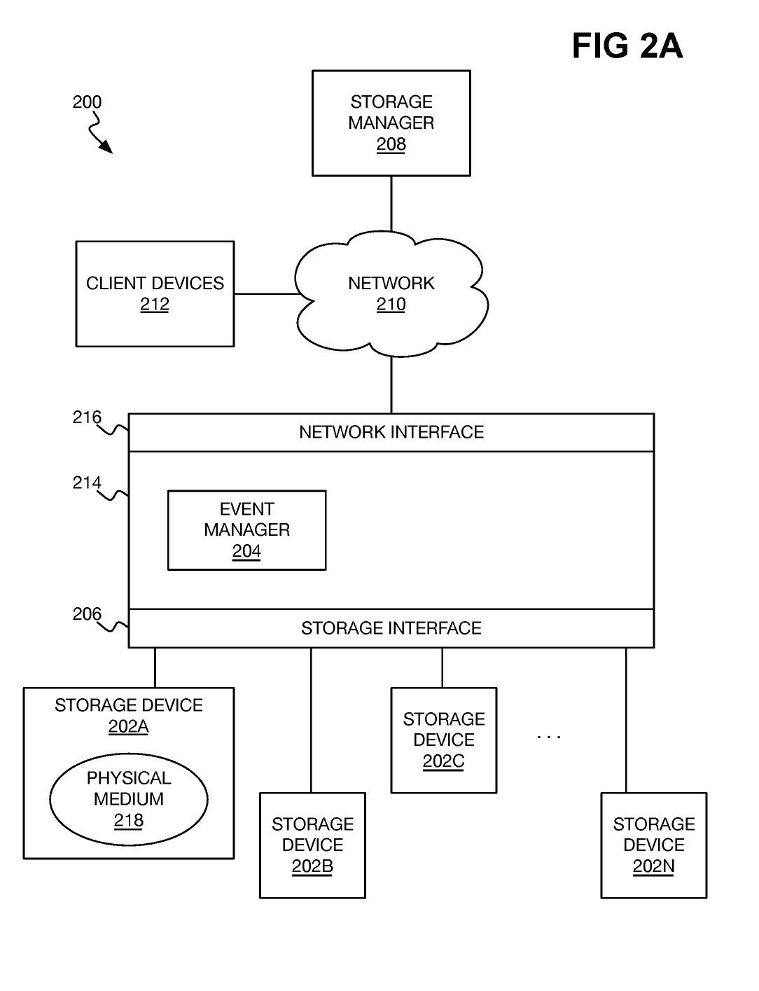

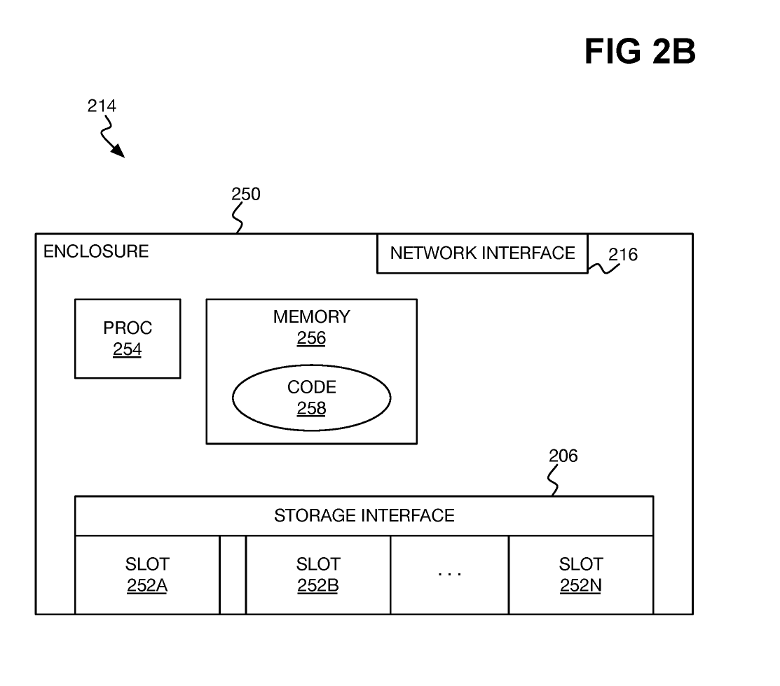

FIG. 2A shows an example physical architectural storage topology 200. The physical topology 200 can implement the logical topology 100 of FIG. 1 in one implementation. The physical topology 200 includes a number of storage devices 202A, 202B, . . . , 202N, which are collectively referred to as the storage devices 202. The singular phrase “storage device 202” refers to one of the storage devices 202. The storage devices 202 can be the storage devices 102A or the storage devices 102B of FIG. 1. The storage device 202A representatively depicts in FIG. 2A that a storage device 202 includes a physical medium 218 on which data, including client data, is stored. The physical medium 218 is a medium like a non-volatile semiconductor memory or a magnetic medium including rotatable hard disk drive platters.

The physical topology 200 includes an event manager 204 that is implemented as part of an event manager device 214. The event manager 204 can be the event manager 104A or 104B of FIG. 1. Just one event manager 204 is depicted in FIG. 2A as an illustrative example. However, there can be more than one event manager 204, in which case each event manager 204 has its own corresponding event manager device 214. The event manager 204 can be implemented as computer-executable code that can be stored on a memory and executed by a processor. In this respect, the event manager 204 may be implemented as an application-specific integrated circuit (ASIC), a field-programmable gate array, (FPGA), or in another manner.

The event manager device 214 includes a physical storage interface 206, which is the local connection 106 in FIG. 2, to which the storage devices 202 are locally connected. The physical storage interface 206 may be a Peripheral Component Interconnect Express (PCIe) interface, in which case the storage devices 202 may be non-volatile memory Express (NVMe) storage devices that are inserted into separate PCIe slots of the interface 206. The physical storage interface 206 may be a serial AT Attachment (SATA) storage interface, in which case the storage devices 202 may be hard disk drives or SSDs having SATA connectors that are connected to corresponding SATA connectors of the interface 206. The physical storage interface 206 may be a Small Computer System Interface (SCSI) storage interface, such as a serial attached SCSI (SAS) storage interface, in which case the storage devices 202 may be hard disk drives or SSDs having SCSI connectors that are connected to corresponding SCSI connectors of the interface 206.

The event manager device 214 includes a network interface 216, such as an Ethernet interface, a Fiber Channel (FC) interface, or another type of network interface. The network interface 216 communicatively connects the event manager device 214 to a corresponding network 210, such as an Ethernet network or an FC fabric. An Ethernet network in the former respect can include local-area networks (LANs), wide-area networks (WANs), intranets, extranets, the Internet, and so on.

Also connected to the network 210 is the storage manager 208, which can implement the storage manager 108 of FIG. 1, and one or more client computing devices 212. There can be more than one storage manager 208. The storage manager 208 manages client data of the client computing devices 212 on the storage devices 202. The storage manager 208 may be implemented on a separate computing device, such as a server, or on one of the client computing devices 212. In the latter implementation, each client computing device 212 can have its own storage manager, or the storage manager of one client device 212 may manage client data storage for more than one client device 212.

In the physical topology 200, the network 210 forms at least part of the remote connection 110 of FIG. 1 between the storage manager 208 and the storage devices 202. Because the storage manager 208 is not part of the event manager device 214, the storage manager 208 cannot directly detect connection of the storage devices 202 to and disconnection of the storage devices 202 from the storage interface 206. However, because the event manager 204 is part of the event manager device 214, the event manager 204 can directly detect such connection and disconnection.

Access to the storage devices 202 over the network 210 thus occurs through the event manager device 214, but does not involve the event manager 204 directly. Rather, another part of the event manager device 214 does. Thus, the storage manager 208 manages the storage devices 202 to instantiate logical storage volumes and to manage higher-level storage functionality on the storage devices 202, in accordance with which the client devices 212 then can access client data on the storage devices 202. The event manager 204 is responsible for detecting connection and disconnection of the storage devices 202 to and from the storage interface 206, and to provide notifications for corresponding reinsertion and removal events to the storage manager 208.

FIG. 2B shows a block diagram of an example event manager device 214 of the physical architectural topology 200 in more detail. The event manager device 214 includes an enclosure in which the storage interface 206 and the network interface 216 are disposed. The event manager device 214 includes a number of slots 252A, 252B, . . . , 252N, collectively referred to as the slots 252, within the enclosure 250 and which are each receptive to insertion and connection of a corresponding storage device 202 of FIG. 2A. The event manager device 214 includes within the enclosure 250 a processor 254 and a memory 256, such as a semiconductor memory, which stores computer-executable code 258 that the processor 254 executes. The processor 254 executes the code 258 to realize or implement the event manager 204 of FIG. 2A.

In the physical architectural topology 200 that has been described, the storage devices 202 can be conventional, or “dumb” drives that lack any processing capability other than an internal read/write controller to manage low-level access to the data stored on a physical storage medium of the drive. Such conventional drives include the aforementioned NVMe, SCSI (including SAS), and SATA storage devices. As such, the topology 200 permits the separation of client data storage management within a storage manager 208 that is remotely connected to the event management device 214 including the event manager 204, via the network 210. This is because the event manager 204 provides notifications of removal and insertion events regarding the devices 202, which the storage manager 208 would only otherwise be able to detect directly if the storage manager 208 were a part of the device 214.

However, the storage devices 202 can in another implementation be programmable, or “smart,” storage drives, like Ethernet-attached programmable storage drives. A programmable storage drive can lack a PCIe, SCSI (including SAS), SATA, or other type of storage interface that is commonly found in a conventional drive. Rather, such a programmable storage drive may just include a network interface by which to connect to a network fabric. A programmable storage drive generally includes a processor and a limited amount of memory, permitting the drive to have an operating system, such as a version of the LINUX operating system, installed thereon and run relatively small-scale applications.

In such an implementation, the storage interface 206 may be a series of network interfaces that can each connect to one corresponding programmable storage device 202. This permits the event manager 204 to be able to detect connection and disconnection of a storage device 202 to and from the storage interface 206. As such, although the storage device 202 is programmable, the device 202 does not have to be programmed, and can be effectively treated as a conventional storage device lacking any programming capability within the physical architectural topology 200.

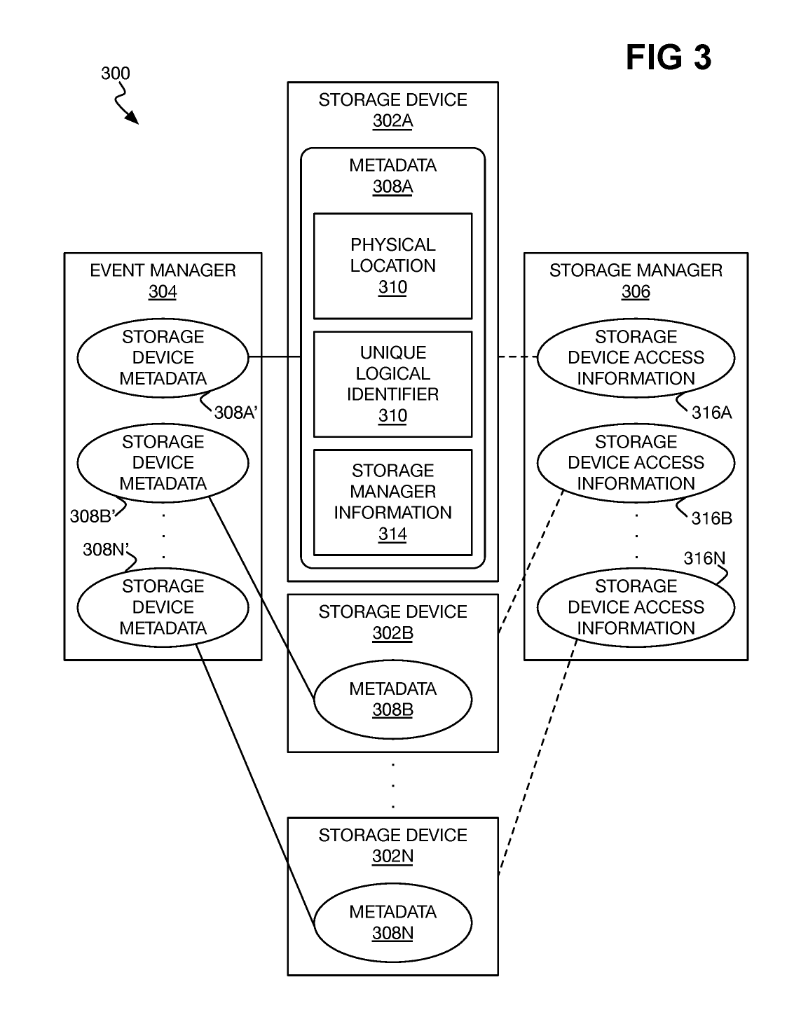

FIG. 3 shows a diagram depicting example data stored within a system 300. The system 300 includes storage devices 302A, 302B, . . . , 302N, collectively referred to as the storage devices 302. As used herein, the singular phrase “storage device 302” refers to one of the storage devices 302. The system 300 includes an event manager 304 to which the storage devices 302 are locally connected, and a storage manager 306 to which the storage devices 302 are remotely connected. One event manager 304 and one storage manager 306 are depicted within the system 300, but in general, there can be more than one event manager 304 and more than one storage manager 306.

The event manager 304 directly maintains and manages metadata 308A, 308B, . . . , 308N, collectively referred to as the metadata 308, on the storage devices 302A, 302B, . . . , 302N, respectively. For instance, the event manager 304 may store the metadata 308 on administrative sections of the storage devices 302, such as partitions or namespaces. The event manager 304 also caches local copies of the metadata 308, which is identified as metadata 308A′, 308B′, . . . , 308N′ in FIG. 3, and which is collectively referred to as the metadata 308′. The event manager 308 may store the metadata 308′ on a local storage thereof, such as an internal non-volatile memory or hard disk drive that is part of or connecting the computing device on which the event manager 308 is running, aside from the storage device 302.

The metadata 308A is with respect to the storage device 302A, the metadata 308B is with respect to the storage device 302B, and so on. The metadata 308A of the storage device 302A is particularly depicted in detail in FIG. 3 as representative of the metadata 308 of the storage devices 302. The metadata 308A includes the physical location 310 of the storage device 302A. The physical location 310 identifies the event manager 304 to which the storage device 302A is locally connected. For example, the physical location 310 may include a network address of the computing device on which the event manager 304 is running. The physical location 310 may further identify a particular port, slot, connector, or other information of the computing device on which the event manager 304 to which the storage device 302A is particularly connected, as compared to other of the storage devices 302 connected to the device on which the event manager 304 is running. The event manager 304 thus stores the physical location of the event manager 304 as the physical location 310 of the storage device 302A within the metadata 308A.

The metadata 308A of the storage device 302A includes a unique logical identifier 312 of the storage device 302A, which uniquely identifies the storage device 302A as compared to any other storage device, include the other storage devices 302, of the system 300. For example, the unique logical identifier 312 may be a serial number of the storage device 302A, a worldwide name (WWN) for an FC storage device, or another type of universally unique identifier (UUID). The event manager 304 may retrieve a serial number or WWN from a read-only memory (ROM) of the storage device 302A and subsequently store it as the unique logical identifier 312 within the metadata 308A, or may generate another type of UUID and store the UUID as the unique logical identifier 312 within the metadata 308A, for instance.

The metadata 308A includes storage manager information 314 of each storage manager, such as the storage manager 306, which is to manage client data stored on the storage device 302A. The storage manager information 314 can include the network address of the computing device running the storage manager 306, for instance. After the storage device 302A has been connected to the system 300 for the first time, an administrator can configure which storage managers are to manage client data on the storage device 302A. This information is provided to the event manager 304, which stores the information as (part of) the storage manager information 314 within the metadata 308A. Whereas while the unique logical identifier 312 of the storage device 302A may not change, and the physical location 310 does not change while connected to the event manager 304, the storage manager information 314 may change over time, as different storage managers are configured to manage client data storage on the storage device 302A.

When a storage manager 306 is configured by a network administrator to manage client data storage on the storage device 302A, then, the event manager 304 receives the information regarding the storage manager 306 and stores the information as the storage manager information 314. The event manager 304 can further notify the storage manager 306 how to access the storage device 302A to which the event manager 304 is locally connected, which the storage manager 306 stores as storage device access information 316A for the storage device 302A. For example, the storage device access information 316A can include the network address of the computing device running the event manager 304, and the unique logical identifier 312 of the storage device 302A. Thus, the storage device access information 316A may include the physical location 310 and the unique logical identifier 312 of the metadata 308A regarding the storage device 302A.

Therefore, for each storage device for which the storage manager 306 is to manage client data storage, the storage manager 306 stores corresponding storage device access information. In the example of FIG. 3, the storage manager 306 manages the storage of client data for each storage device 302, and therefore stores storage device access information 316A, 316B, . . . , 316N, collectively referred to as the storage device access information 316. So long as a storage device 302 remains connected to the same event manager 304, the corresponding storage device access information 316 for the storage device 302 may not change. Rather, the storage device access information 316 may change just as the storage devices 302 are disconnected from the event manager 304 and (re)connected to a different event manager within the system 300. At that time, the latter event manager provides updated storage device access information 316 to the storage manager 306.

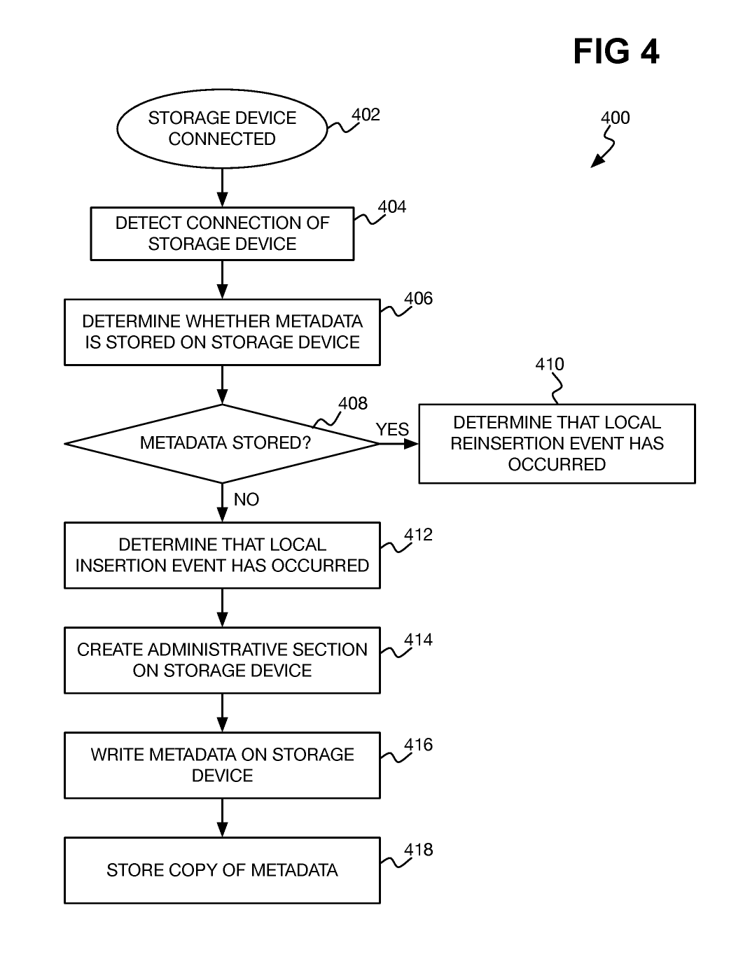

FIG. 4 shows an example method 400 that an event manager performs when a storage device is locally connected to the event manager. The storage device may have been previously connected to the event manager performing the method 400, or may have may have been previously connected to a different event manager. The storage device may alternatively have not been connected to any event manager previously.

As such, a storage device is connected to the local connection between the event manager and storage device (402). For example, an administrator may connect the storage device to a storage interface like a SATA, PCIe, or SCSI (including SAS), interface. The event manager detects the local connection of the storage device (404). The event manager is able to detect the connection of the storage device since the storage device is locally connected to the event manager (i.e., the storage device is connected to the device on which the event manager is running). Different types of storage interfaces, including SATA, PCIe, and SCSI, for instance, result in an interrupt being generated when a storage device is connected to or disconnected from the interface. Therefore, the event manager can trap or otherwise receive this interrupt.

The event manager next determines whether the storage drive stores metadata that the event manager performing the method 400 or another event manager previously stored on the storage drive (406). As one example, the event manager may determine whether an administrator section, such as a namespace or partition, has been previously created on the storage device by the event manager or another event manager.

The event manager can then determine whether the administrator section includes the metadata that has been described above in relation to FIG. 3.

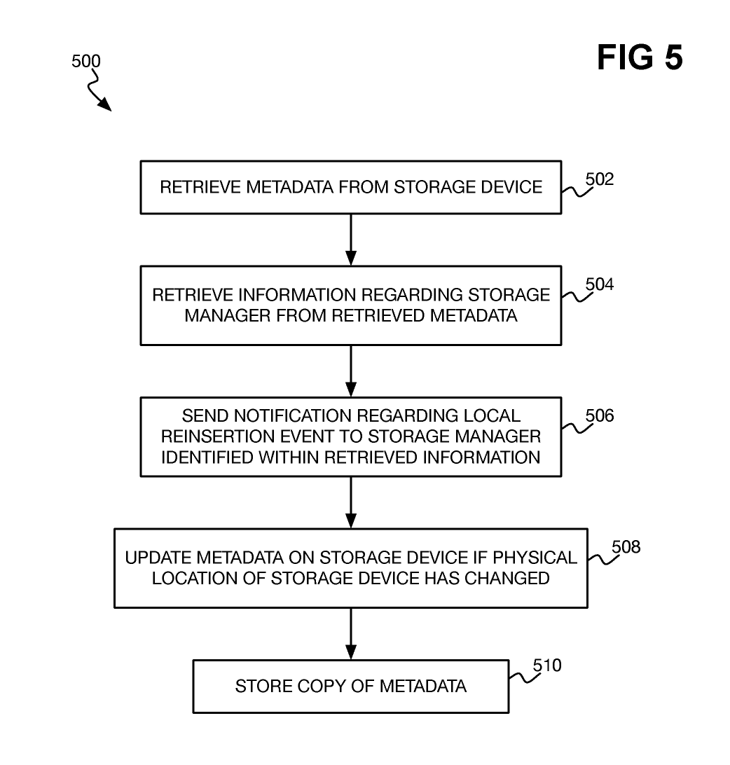

If such metadata is stored on the storage device (408), then this means that the storage device was previously connected to the event manager or to another event manager. Therefore, the event manager determines that a local reinsertion event has occurred (410), and the method 500 described later in the detailed description in relation to FIG. 5 is performed. Stated another way, the event manager detects connection of the storage device as the receiving of a local reinsertion event.

By comparison, if metadata is not stored on the storage device (408), then this means that the storage device was not previously connected to the event manager or to another event manager. Therefore, the event manager determines that a local insertion event has occurred (412), and the remainder of the method 400 is performed. Stated another way, the event manager detects connection of the storage device as the receiving of a local insertion event.

The event manager creates an administrative section on the storage device (414), and writes metadata to the administrative section on the storage device (416). The metadata includes the physical location of the storage device from which the event manager is itself identifiable, the unique logical identifier of the storage device, and information regarding each storage manager that is to manage storage of client data on the storage device, as has been described. The event manager can write the physical location of the storage device and the unique logical identifier as soon as the event manager has created the administrative section on the storage device.

However, the event manager may not have the information regarding each storage manager that is to manage storage of client data on the storage device at the time when the administration section is created on the storage device. This is because an administrator may not have yet configured any storage manager to mange client data storage on the storage device. Therefore, the storage manager information of the metadata may not be written on the storage device until later, when this information becomes available as a result of administrator configuration. Furthermore, the storage manager information may be periodically updated, as different storage managers are configured to manage client data storage on the storage device, or as existing storage managers that manage such client data storage are reconfigured so that they no longer manage client data storage on the storage device.

The event manager also stores on a local storage thereof a copy of the metadata written on the storage device (418). This ensures that if the storage device is disconnected from local connection to the event manager without prior notification, the event manager is able to look up each storage manager that was managing client data storage on the storage device; such storage manager information could not be retrieved from the storage device itself because the storage device is no longer connected. Because the method 400 is performed each time a storage device is connected to the event manager, the event manager thus stores a copy of the metadata regarding each storage device locally connected to the event manager. This means in effect that the event manager stores storage manager information regarding every storage manager managing the storage of client data on any storage device locally connected to the event manager. As an administrator reconfigures which storage managers manage client data storage on the storage device, the event manager updates the metadata stored on the storage device in part 416 and updates its local copy of the metadata in part 418.

FIG. 5 shows an example method 500 that an event manager performs when a storage device that was previously connected to the event manager or another event manager is locally connected to the event manager. The method 500 is performed when a local reinsertion event has been detected, per part 410 of the method 400. That is, the connection of the storage device to the event manager has been detected, and the event manager has determined that the storage device stores metadata that the event manager or another event manager previously stored on the storage device.

The event manager retrieves the metadata from the storage device (502). From this metadata, the event manager retrieves information regarding each storage manager that manages client data storage on the storage device (504), and sends a notification regarding the local reinsertion event to each such storage manager (506). If the storage device is connected to the same event manager as it was previously, then the notification may just indicate that the storage device has been reconnected to the event manager.

However, the storage device may be connected to a different event manager than it was previously. In this case, the notification may include information regarding the event manager, such as the network address of the computing device on which the event manager is running, to permit the storage manager to use the storage device in its new location. For example, the storage device may have initially been connected to a first event manager running on a first computing device having a first network address. A storage manager managing client data storage on the storage device thus accesses the storage device at this first network address. If the storage device is disconnected and connected to a second event manager running on a second computing device having a second network address, the second event manager can send a notification regarding this local reinsertion event to the storage manager. As part of the notification, the second event manager includes the second network address. Therefore, the storage manager learns the new location of the storage device, and is able to continue managing client data storage on the storage device at this new location via the provided second network address.

If the physical location of the storage device has changed—that is, if the event manager to which the storage device has been connected is not the same event manager to which the storage device was previously connected—then the event manager also updates the metadata stored on the storage device (508). The metadata is updated with the new physical location of the storage device, which is the location of the event manager running the method 500 to which the storage device is now connected. That is, the event manager is identifiable from the physical location of the storage device. The event manager then stores a copy of the metadata on a local storage of the event manager (510).

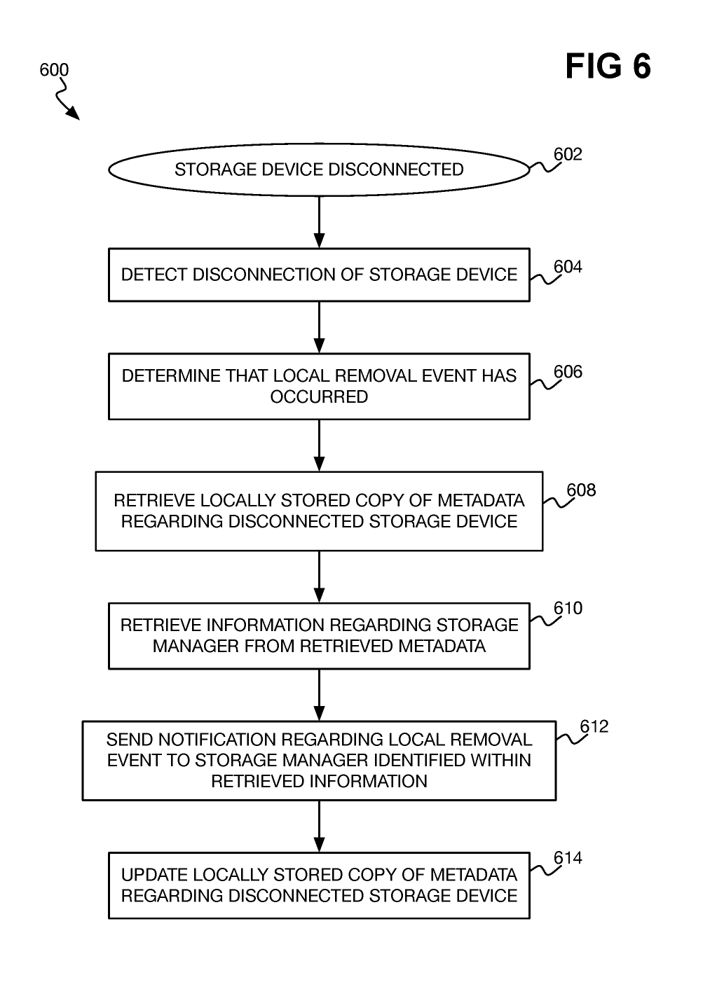

FIG. 6 shows an example method 600 that an event manager performs when a storage device is locally disconnected from the event manager. The storage device has been previously connected to the event manager performing the method 600. As such, the storage device is disconnected from the local connection between the event manager and the storage device (602). For example, an administrator may disconnect the storage from a storage interface lake a SATA, PCIe, or SCSI (including SAS), interface.

The event manager detects the local physical disconnection of the storage device (604). The event manager is able to detect the disconnection of the storage device since the storage device was previously locally connected to the event manager (i.e., the storage device was previously connected to the device on which the event manager is running). Different types of storage interfaces, including SATA, PCIe, and SCSI, for instance, result in an interrupt being generated when a storage device is disconnected from the interface. The event manager can thus trap or otherwise receive this interrupt.

The event manager is thus said to determine that a local removal event has occurred (606). Stated another way, the event manager detects disconnection of the storage device as the receiving of a local removal event. The event manager retrieves the copy of the metadata regarding the disconnected storage device that the event manager previously stored locally (608). For instance, detection of the disconnection of the storage device may occur by an interrupt that identifies a particular part, slot, connector, or other information of the computing device on which the event manager is running, and from which the storage device has been connected. The event manager can compare this information against all the metadata that the event manager locally stores to identify the particular storage device that has been disconnected.

From this locally stored copy of the metadata regarding the disconnected storage device, the event manager retrieves information regarding each storage manager that has been managing client data storage on the storage device (610), and sends a notification regarding the local removal event to each such storage manager (612). For instance, the event manager can notify each storage manager that has been managing client data storage on the storage device the identity of the storage device, along with an indication that the storage device is no longer connected. A storage manager may or may not have been previously notified, by an administrator for example, that the storage device will be disconnected. If the storage manager was previously notified, then the storage manager may have already prepared for ultimate physical disconnection of the storage device, by dismounting and removing logical volumes that have instantiated on the storage device, and so on. Therefore, the notification of the local removal event provides final confirmation that the storage device is no longer accessible.

If the storage manager was not previously notified, then the storage manager may react depending on how the storage manager was managing client data storage on the disconnected storage device. For example, if the storage device was storing a mirror copy of client data, then the client data is still accessible on other storage devices that remain connected. Somewhat similarly, if the storage device was participating in a RAID-type topology for client data storage, then the storage manager may initiate rebuilding of the redundant array using an available hot spare storage device, or wait until a cold spare storage device has been connected (or until the disconnected storage device has been reconnected). If the storage device was participating in a non-redundant storage topology like striping, or otherwise was the sole online location at which client data was stored, then the storage manager may notify client computing devices that their client data is no longer available.

The event manager updates its locally stored copy of the metadata regarding the disconnected storage device as well (614). The event manager may, for instance, update the metadata to denote that the storage device in question is no longer currently locally connected to the event manager. In one implementation, the event manager may just delete its locally stored copy of the metadata regarding the disconnected storage device. Because the storage device itself stores this metadata, if the storage device is reconnected locally to the event manager, the event manager can therefore retrieve the metadata at that time, and store a new local copy of the metadata regarding the storage device.

The techniques that have been disclosed herein therefore provide for a way by which storage managers that manage client data storage on storage devices can located remotely from the storage devices, even if the storage devices are “dumb” storage devices that are not programmable and that otherwise lack the ability to run versions of operating systems. Whereas conventionally storage managers for such types of storage devices have to be locally connected to the storage devices, the techniques disclosed herein provide for event managers that remain locally connected to the storage devices, but which do not manage client data storage on the storage devices. Therefore, performance bottlenecks and other disadvantages associated with locating storage device management physically proximate to the storage devices are ameliorated.

It is finally noted that, although specific embodiments have been illustrated and described herein, it will be appreciated by those of ordinary skill in the art that any arrangement calculated to achieve the same purpose may be substituted for the specific embodiments shown. This application is thus intended to cover any adaptations or variations of embodiments of the present invention. Examples of computer-readable media include both volatile such media, like volatile semiconductor memories, as well as non-volatile such media, like non-volatile semiconductor memories and magnetic storage drives. It is manifestly intended that this invention be limited only by the claims and equivalents thereof.

We claim:

1. A storage system comprising:
a plurality of storage devices, each storage device having a physical medium on which to store metadata regarding the storage device, and client data;
a storage manager remotely connected to the storage devices to manage storage of the client data on the storage devices; and
an event manager separate from the storage manager and locally connected to the storage devices to directly manage the metadata stored on the storage devices, to receive local insertion, removal, and reinsertion events regarding the storage devices, and to send notifications regarding the removal and the reinsertion events to the storage manager.

2. The storage system of claim 1, wherein responsive to receiving a local insertion event regarding a storage device new to the storage system, the event manager is to:
create an administrative section on the storage device to store the metadata regarding the storage device;
write the metadata to the administrative section, the metadata including:
a physical location of the storage device, the event manager identifiable from the physical location of the storage device;
a unique logical identifier of the storage device; and
information regarding the storage manager that is to manage the storage of the client data on the storage device; and
store a copy of the metadata locally within a local storage of the event manager.

3. The storage system of claim 2, wherein responsive to receiving a local removal event regarding the storage device for which the local insertion event was previously received, the event manager is to:
retrieve the information regarding the storage manager from the copy of the metadata stored locally within the local storage;
send a notification regarding the local removal event to the storage manager identified within the retrieved information; and
update the copy of the metadata stored locally within the local storage to indicate that the storage device is no longer locally connected to the event manager.

4. The storage system of claim 3, wherein responsive to receiving a local reinsertion event regarding the storage device for which the local removal event was previously received, the event manager is to:
retrieve the metadata from the administrative section of the storage device;
retrieve the information regarding the storage manager from the retrieved metadata;
send a notification regarding the local reinsertion event to the storage manager identified within the retrieved information; and
store the copy of the metadata locally within the local storage of the event manager.

5. The storage system of claim 3, wherein the event manager is a first event manager, and the storage system further comprises:
a second event manager separate from the storage manager,
wherein responsive to receiving a local reinsertion event regarding the storage device for which the first event manager previously received the local removal event, the event manager is to:
retrieve the metadata from the administration section of the storage device;
retrieve the information regarding the storage manager from the retrieved metadata;
send a notification regarding the local reinsertion event to the storage manager identified within the retrieved information; and
store the copy of the metadata locally within a local storage of the second event manager.

6. The storage system of claim 5, wherein the storage manager manages the storage of the client data on the storage device for which the second event manager received the local reinsertion event regardless of the location of the storage device and regardless of whether the storage device is locally connected to the first event manager or the second event manager.

7. The storage system of claim 1, wherein the event manager is a first event manager, and the storage system further comprises:
a second event manager separate from the storage manager,
wherein the storage devices are transitionable between local connection to the first event manager and local connection to the second event manager without affecting management of the storage of the client data on the storage devices by the storage manager.

8. The storage system of claim 1, wherein the event manager is a first event manager, and the storage system further comprises:
a second event manager separate from the storage manager,
wherein separation of the storage manager from the first and second event managers permits the storage manager to manage the storage of the client data on the storage devices regardless of whether any storage device is currently locally connected to the first event manager or the second event manager.

9. The storage system of claim 1, wherein the event manager is to create an administrative section on each storage device on which to store the metadata,
wherein the metadata of each storage device comprises a physical location of the storage device from which the event manager is identifiable, a unique logical identifier of the storage device, and information regarding the storage manager that is to manage the storage of the client data on the storage device,
and wherein the event manager is to store a copy of the metadata of each storage device within a local storage of the event manager.

10. The storage system of claim 9, wherein the storage manager is to store information regarding each storage device that the storage manager manages the storage of the client data thereon,
wherein the event manager is to store information regarding every storage manager managing the storage of the client data on any storage device to which the event manager is locally connected.

11. The storage system of claim 1, further comprising:
a storage manager computing device implementing the storage manager and connectable to a network;
an event manager computing device implementing the event manager and connectable to the network; and
a local storage interface of the event manager computing device to which the storage devices are connected.

12. A computer-readable data storage medium that is not a transitory signal storing computer-executable code that an event manager separate from a storage manager managing client data storage executes to:
detect connection of a storage device;
in response to detecting the connection of the storage device, determine whether the storage device has an administrative section including metadata regarding the storage device;
in response to determining that the storage device has the administrative section, determining that a local reinsertion event of the storage device has occurred;
in response to determining that the local reinsertion event has occurred, retrieve the metadata from the administrative section of the storage device;
retrieve information regarding the storage manager that previously managed the storage of the client data on the storage device;
send a notification regarding the local reinsertion event to the storage manager identified within the retrieved information; and
store a copy of the metadata locally within a local storage of the event manager.

13. The computer-readable medium of claim 12, wherein prior to connection of the storage device to the event manager, the storage device was disconnected from a different event manager that created the administrative section and wrote the metadata to the administration section.

14. The computer-readable medium of claim 12, wherein the event manager executes the computer-executable code to further:
in response to determining that the storage device does not have the administrative section, determine that a local insertion event of the storage device has occurred;
in response to determining that the local insertion event has occurred, create the administrative section to store the metadata;
after creating the administrative section, write the metadata to the administrative section, including:
a physical location of the storage device, the event manager identifiable from the physical location of the storage device;
a unique logical identifier of the storage device; and
the information regarding the storage manager that is to manage the storage of the client data on the storage device;
store the copy of the metadata locally within the local storage of the event manager.

15. The computer-readable medium of claim 12, wherein the event manager executes the computer-executable code to further:
detect disconnection of the storage device;
in response to detecting the disconnection of the storage device, determine that a local removal event of the storage device has occurred;
in response to determining that the local removal event has occurred, retrieve the information regarding the storage manager managing the storage of the client data on the storage device from the copy of the metadata stored locally within the local storage;
send a notification regarding the local removal event to the storage manager identified within the retrieved information; and
update the copy of the metadata stored locally within the local storage to indicate that the storage device is no longer locally connected to the event manager.

16. The computer-readable medium of claim 15, wherein subsequent to disconnection of the storage device from the event manager, the storage device is connectable to a different event manager that sends a notification regarding a corresponding local reinsertion event to the storage manager, permitting the storage manager to continue managing the storage of the client data on the storage device.

17. An event manager apparatus comprising:
a local storage interface;
a plurality of storage devices, each storage device connected to the local storage interface and having a physical medium on which to store metadata regarding the storage device and client data;
a network interface to connect to a network to which a storage manager managing storage of the client data on the storage devices is connected; and
an event manager to directly manage the metadata stored on the storage devices, to receive local insertion, removal, and reinsertion events regarding the storage devices, and to send notifications regarding the removal and the reinsertion events to the storage manager over the network.

18. The event manager apparatus of claim 17, further comprising:
an enclosure in which the local storage interface, the storage devices, and the network interface are disposed,
wherein the enclosure has a plurality of slots into which the storage devices are removably inserted.

19. The event manager apparatus of claim 18, further comprising:
a processor disposed within the enclosure; and
a memory disposed within the enclosure and storing computer-executable code that the processor executes to implement the event manager.

20. The event manager apparatus of claim 17, wherein for each storage device, the metadata comprises:
a physical location of the storage device, the event manager identifiable from the physical location of the storage device;
a unique logical identifier of the storage device; and
information regarding the storage manager that is to manage the storage of the client data on the storage device.
